(19) United States
(12) Patent Application Publication
(10) Pub. No.: US 2019/0025921 A1
(43) Pub. Date: Jan. 24, 2019

(54) Method, Device, and System for Providing User Interface, and Non-Temporary Computer-Readable Recording Medium

(71) Applicant: FUTUREPLAY INC., Seoul (KR)

(72) Inventor: Sungjae HWANG, Seoul (KR)

(21) Appl. No.: 15/780,291

(22) PCT Filed: Nov. 30, 2016
(86) PCT No.: PCT/KR2016/013929

§ 371 Date: Jul. 26, 2018

(30) Foreign Application Priority Data
Dec. 1, 2015 (KR) 10-2015-0169742

(51) Int. Cl. G06F 3/01; G06F 3/0488; G06F 3/0354; G02B 27/01; G06T 19/00

(52) U.S. Cl. CPC G06F 3/016; G06F 3/04883; G06F 2203/04808; G02B 27/0172; G06T 19/006; G06F 3/03545

(57) ABSTRACT

A method for providing a user interface includes determining whether a triggering event occurs that causes haptic feedback in a first device or a second device; and when it is determined that the triggering event occurs, controlling properties of haptic feedback provided in the first and second devices, with reference to at least one of information on interaction between the first and second devices associated with the triggering event, information on a position, posture, or motion of the first or second device associated with the triggering event, information on pressure applied to the first or second device associated with the triggering event, information on a display state associated with the triggering event, and information on contents or functions associated with the triggering event. The properties of haptic feedback provided in the first device and the properties of haptic feedback provided in the second device are complementarily controlled.

### CROSS-REFERENCE TO RELATED APPLICATION(S)

This application is a U.S. national phase of Patent Cooperation Treaty (PCT) International Application Serial No. PCT/KR2016/013929, filed on Nov. 30, 2016, which claims priority to Korean Patent Application Serial No. 10-2015-0169742, filed on Dec. 1, 2015. The entire contents of PCT International Application Serial No. PCT/KR2016/013929 and Korean Patent Application Serial No. 10-2015-0169742 are hereby incorporated by reference.

### FIELD OF THE INVENTION

The present invention relates to a method, device, system, and non-transitory computer-readable recording medium for providing a user interface.

### BACKGROUND

Recently, mobile smart devices having various communication and sensing capabilities and powerful computing capabilities, such as smart phones and smart pads, are being widely used. Among such mobile smart devices, there are relatively small-sized ones that may be worn and carried on a body of a user (e.g., a smart glass, a smart watch, a smart band, a smart device in the form of a ring or a brooch, a smart device directly worn on or embedded in a body or a garment, etc.)

In this situation, a user may desire to perform a task using two or more (different kinds of) smart devices of the user, or may desire a task to be performed in which smart devices of the user and another user are required to be involved together. Further, the user may desire to intuitively receive information on the performance state of the task. However, this (latent) intention and needs of the user could not have been properly supported in prior art.

### SUMMARY OF THE INVENTION

One object of the present invention is to fully solve the above problem.

Another object of the invention is to intuitively provide a user, via haptic feedback, with information on a task performed in a state in which two or more devices are associated, by determining whether a triggering event occurs that causes haptic feedback in at least one of a first device and a second device, and when it is determined that the triggering event occurs, controlling properties of haptic feedback provided in the first device and the second device, with reference to at least one of information on interaction between the first device and the second device associated with the triggering event, information on a position, posture, or motion of the first device or the second device associated with the triggering event, information on pressure applied to the first device or the second device associated with the triggering event, information on a display state associated with the triggering event, and information on contents or functions associated with the triggering event.

The representative configurations of the invention to achieve the above objects are described below.

According to one aspect of the invention, there is provided a method for providing a user interface, comprising the steps of: determining whether a triggering event occurs that causes haptic feedback in at least one of a first device and a second device; and when it is determined that the triggering event occurs, controlling properties of haptic feedback provided in the first device and the second device, with reference to at least one of information on interaction between the first device and the second device associated with the triggering event, information on a position, posture, or motion of the first device or the second device associated with the triggering event, information on pressure applied to the first device or the second device associated with the triggering event, information on a display state associated with the triggering event, and information on contents or functions associated with the triggering event, wherein the properties of haptic feedback provided in the first device and the properties of haptic feedback provided in the second device are complementarily controlled, and wherein the second device is a smart pen device capable of interacting with the first device.

According to another aspect of the invention, there is provided a device for providing a user interface, comprising: a sensing module configured to determine whether a triggering event occurs that causes haptic feedback in at least one of the device and another device; and a program module configured to, when it is determined that the triggering event occurs, control properties of haptic feedback provided in the device and the another device, with reference to at least one of information on interaction between the device and the another device associated with the triggering event, information on a position, posture, or motion of the device or the another device associated with the triggering event, information on pressure applied to the device or the another device associated with the triggering event, information on a display state associated with the triggering event, and information on contents or functions associated with the triggering event, wherein the properties of haptic feedback provided in the device and the properties of haptic feedback provided in the another device are complementarily controlled, and wherein the another device is a smart pen device capable of interacting with the device.

According to yet another aspect of the invention, there is provided a system for providing a user interface, comprising: a control unit configured to determine whether a triggering event occurs that causes haptic feedback in at least one of a first device and a second device, and when it is determined that the triggering event occurs, control properties of haptic feedback provided in the first device and the second device, with reference to at least one of information on interaction between the first device and the second device associated with the triggering event, information on a position, posture, or motion of the first device or the second device associated with the triggering event, information on pressure applied to the first device or the second device associated with the triggering event, information on a display state associated with the triggering event, and information on contents or functions associated with the triggering event; and a storage configured to store information provided from at least one of the first device and the second device, wherein the properties of haptic feedback provided in the first device and the properties of haptic feedback provided in the second device are complementarily controlled, and wherein the second device is a smart pen device capable of interacting with the first device.

In addition, there are further provided other methods, devices and systems to implement the invention, as well as non-transitory computer-readable recording media having stored thereon computer programs for executing the methods.

According to the invention, information on a task performed in a state in which two or more devices are associated may be intuitively provided to a user via haptic feedback.

According to the invention, various patterns of haptic feedback may be provided to enable direct sensing of information on a task performed between a device worn on a body of a user and a device not worn thereon, or a task performed between two or more devices worn on the body of the user.

According to the invention, a user using a digital device may be provided with a real feel of using an actual pen or pencil.

### BRIEF DESCRIPTION OF THE DRAWINGS

FIG. 1 schematically shows the configuration of an entire system for providing a user interface according to one embodiment of the invention.

FIG. 2A illustratively shows how to control properties of haptic feedback with reference to physical properties, including a position, posture, or motion, of a first device or a second device according to one embodiment of the invention.

FIG. 2B illustratively shows how to control properties of haptic feedback with reference to physical properties, including a position, posture, or motion, of a first device or a second device according to one embodiment of the invention.

FIG. 3A illustratively shows how to control properties of haptic feedback with reference to physical properties, including a position, posture, or motion, of a first device or a second device according to one embodiment of the invention.

FIG. 3B illustratively shows how to control properties of haptic feedback with reference to physical properties, including a position, posture, or motion, of a first device or a second device according to one embodiment of the invention.

FIG. 3C illustratively shows how to control properties of haptic feedback with reference to physical properties, including a position, posture, or motion, of a first device or a second device according to one embodiment of the invention.

FIG. 4A illustratively shows how to control properties of haptic feedback with reference to physical properties, including a position, posture, or motion, of a first device or a second device according to one embodiment of the invention.

FIG. 4B illustratively shows how to control properties of haptic feedback with reference to physical properties, including a position, posture, or motion, of a first device or a second device according to one embodiment of the invention.

FIG. 5A illustratively shows how to control properties of haptic feedback with reference to a display state of a region, contents, or functions associated with a triggering event according to one embodiment of the invention.

FIG. 5B illustratively shows how to control properties of haptic feedback with reference to a display state of a region, contents, or functions associated with a triggering event according to one embodiment of the invention.

FIG. 6A illustratively shows how to control properties of haptic feedback with reference to a display state of a region, contents, or functions associated with a triggering event according to one embodiment of the invention.

FIG. 6B illustratively shows how to control properties of haptic feedback with reference to a display state of a region, contents, or functions associated with a triggering event according to one embodiment of the invention.

FIG. 7A illustratively shows how to control properties of haptic feedback with reference to a display state of a region, contents, or functions associated with a triggering event according to one embodiment of the invention.

FIG. 7B illustratively shows how to control properties of haptic feedback with reference to a display state of a region, contents, or functions associated with a triggering event according to one embodiment of the invention.

FIG. 8 illustratively shows how to control properties of haptic feedback with reference to a display state of a region, contents, or functions associated with a triggering event according to one embodiment of the invention.

FIG. 9A illustratively shows how to control properties of haptic feedback with reference to a display state of a region, contents, or functions associated with a triggering event according to one embodiment of the invention.

FIG. 9B illustratively shows how to control properties of haptic feedback with reference to a display state of a region, contents, or functions associated with a triggering event according to one embodiment of the invention.

FIG. 9C illustratively shows how to control properties of haptic feedback with reference to a display state of a region, contents, or functions associated with a triggering event according to one embodiment of the invention.

FIG. 10 illustratively shows how to control properties of haptic feedback with reference to interaction occurring between different kinds of devices according to one embodiment of the invention.

FIG. 11 illustratively shows how to control properties of haptic feedback with reference to interaction occurring between different kinds of devices according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of an Entire System

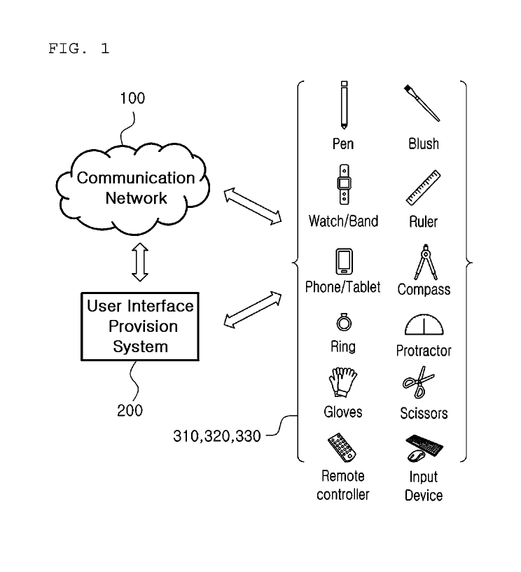

FIG. 1 schematically shows the configuration of an entire system for providing a user interface according to one embodiment of the invention.

As shown in FIG. 1, the entire system according to one embodiment of the invention may comprise a communication network 100, a user interface provision system 200, and multiple devices 310, 320, 330.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

Next, the user interface provision system 200 according to one embodiment of the invention may be digital equipment having a memory means and a microprocessor for computing capabilities. The user interface provision system 200 may be a server system. The user interface provision system 200 may function to mediate so that via the communication network 100, one of the devices 310, 320, 330 may transmit information or a control command to the others, or the one may receive information or a control command from the others.

To this end, as will be described in detail below, the user interface provision system 200 may function to intuitively provide a user, via haptic feedback, with information on a task performed in a state in which two or more devices are associated, by determining whether a triggering event occurs that causes haptic feedback in at least one of a first device and a second device, and when it is determined that the triggering event occurs, controlling properties of haptic feedback provided in the first device and the second device, with reference to at least one of information on interaction between the first device and the second device associated with the triggering event, information on a position, posture, or motion of the first device or the second device associated with the triggering event, information on pressure applied to the first device or the second device associated with the triggering event, information on a display state associated with the triggering event, and information on contents or functions associated with the triggering event.

The provision of the user interface may be performed by a control unit (not shown) included in the user interface provision system 200. The control unit may reside in the user interface provision system 200 in the form of a program module. The program module may be in the form of an operating system, an application program module, or other program modules. Further, the program module may also be stored in a remote storage device that may communicate with the user interface provision system 200. Meanwhile, such a program module may include, but not limited to, a routine, a subroutine, a program, an object, a component, a data structure and the like for performing a specific task or executing a specific abstract data type as will be described below in accordance with the invention.

Further, the user interface provision system 200 may further function to store information on interaction occurring between the multiple devices 310, 320, 330 and allow the information to be used by at least one of the multiple devices 310, 320, 330. Furthermore, the user interface provision system 200 may further function to store information on the occurrence or location of body contact provided from at least one of the multiple devices 310, 320, 330 and allow the information to be used by at least one of the multiple devices 310, 320, 330. In addition, the user interface provision system 200 may further function to store information constituting contents or functions provided in at least one of the multiple devices 310, 320, 330 and allow the information to be used by at least one of the multiple devices 310, 320, 330. The storing may be performed by a storage (not shown) included in the user interface provision system 200. The storage encompasses a computer-readable recording medium, and may refer not only to a database in a narrow sense but also to a database in a broad sense including file-system based data records and the like.

The function of the user interface provision system 200 will be discussed in more detail below. Meanwhile, although the user interface provision system 200 has been described as above, the above description is illustrative and it is apparent to those skilled in the art that at least some of the functions or components required for the user interface provision system 200 may be implemented or included in at least one of the multiple devices 310, 320, 330 to be operated, as necessary.

Lastly, the multiple devices 310, 320, 330 according to one embodiment of the invention are digital equipment that may function to connect to and then communicate with the user interface provision system 200 or a counterpart of the multiple devices 310, 320, 330 (which may preferably be separated or externalized from each other), and any type of digital equipment having a memory means and a microprocessor for computing capabilities may be adopted as the devices 310, 320, 330 according to the invention. The devices 310, 320, 330 may be so-called smart devices such as a smart phone, a smart pad, a smart glass, a smart watch, a smart band, a smart ring, a smart necklace, and a smart pen, or may be somewhat traditional devices such as a desktop computer, a notebook computer, a workstation, a personal digital assistant (PDA), a web pad, a mobile phone, buttons, a mouse, and a keyboard. Further, the devices 310, 320, 330 may be Internet of Things (IoT) devices such as a remote control and a home appliance. Furthermore, the devices 310, 320, 330 may be smart drafting devices that may function as a brush, a compass, a protractor, scissors, a ruler, gloves, and the like.

Particularly, according to one embodiment of the invention, the devices 310, 320, 330 may include at least one technical means for generating haptic feedback (e.g., vibration, electrical impulse, etc.) provided to a user. Examples of the technical means may include commonly known components like haptic feedback generation modules such as an actuator, a vibration motor, and an electrical impulse generator.

Further, according to one embodiment of the invention, the devices 310, 320, 330 may include at least one technical means for receiving an operation from a user. Examples of the technical means may include commonly known components like a touch panel, a pointing tool (e.g., a mouse, a smart pen, etc.), a graphical object operable by the user, a keyboard, a toggle switch, and a sensing module such as a biometrics (like fingerprints) sensor, a distance sensor, and a hovering recognition sensor.

Furthermore, according to one embodiment of the invention, the devices 310, 320, 330 may include at least one technical means for acquiring physical information on positions, postures, or motions of the devices 310, 320, 330. Examples of the technical means may include commonly known components like sensing modules such as a motion sensor, an acceleration sensor, a gyroscope, a magnetic sensor, a positioning module (a GPS module, a beacon-based positioning (position identification) module, etc.), a barometer, a distance sensor, and a camera.

Moreover, according to one embodiment of the invention, the devices 310, 320, 330 may include a technical means for acquiring physical information on positions, postures, or motions of the devices 310, 320, 330 on the basis of biometrics acquired from a body of a user carrying the devices 310, 320, 330. Examples of the technical means may include sensing modules such as an electromyogram (EMG) signal measurement apparatus.

Further, according to one embodiment of the invention, the devices 310, 320, 330 may include a technical means for acquiring physical information on pressure applied by a user carrying the devices 310, 320, 330. Examples of the technical means may include sensing modules such as a pressure sensor.

In addition, the devices 310, 320, 330 may further include an application program for processing the above physical information to transmit information or a control command to another device 310, 320, 330, to receive information or a control command from another device 310, 320, 330, or to generate the information or control command. The application may reside in the corresponding devices 310, 320, 330 in the form of a program module. The nature of the program module may be generally similar to that of the aforementioned control unit of the user interface provision system 200. Here, at least a part of the application may be replaced with a hardware or firmware device that may perform a substantially equal or equivalent function, as necessary.

Meanwhile, according to one embodiment of the invention, when it is recognized that the first device 310 and the second device 320 have an association (e.g., indicating that they belong to the same user, they function for the sake of the same user, they are located substantially close to each other, or one of them is competent to authenticate or permit the other), a connection may be formed between the first device 310 and the second 320. The recognition or connection may be performed by the user interface provision system 200 or by the first device 310 and the second device 320.

### EMBODIMENTS

Hereinafter, specific examples will be discussed in detail wherein the user interface provision system 200 according to the invention provides a user interface in which the multiple devices 310, 320, 330 are involved according to various embodiments of the invention.

According to one embodiment of the invention, the user interface provision system 200 may determine whether a triggering event occurs that causes haptic feedback in at least one of the first device 310 and the second device 320, and when it is determined that the triggering event occurs, control properties of haptic feedback provided in at least one of the first device 310 and the second device 320, with reference to at least one of information on interaction between the first device 310 and the second device 320 associated with the triggering event, information on a position, posture, or motion of the first device 310 or the second device 320 associated with the triggering event, information on pressure applied to the first device 310 or the second device 320 associated with the triggering event, information on a display state associated with the triggering event, and information on contents or functions associated with the triggering event. Here, the second device 320 may be a smart pen device capable of interacting with the first device 310, which includes a display screen having a touch panel.

According to one embodiment of the invention, a triggering event may encompass all types of events that may be sensed by the first device 310, the second device 320, or the user interface provision system 200, in which the first device 310 and the second device 320 may be involved. For example, the triggering event may include an event in which an operation occurs that causes the second device 320 to contact the first device 310, or an event in which an operation occurs that causes the second device 320 to hover over the first device 310. As another example, the triggering event may include an event in which a task such as data transmission, payment, and security authentication is performed between the first device 310 and the second device 320 as the first device 310 and the second device 320 interact with each other. As yet another example, the triggering event may include an event in which a relative relationship between positions, postures, or motions of the first device 310 and the second device 320 corresponds to a predetermined relationship (e.g., a relationship where the second device 320 is tilted at a predetermined angle with respect to the display screen of the first device 310.)

Specifically, in response to the occurrence of a triggering event, the user interface provision system 200 according to one embodiment of the invention may function to determine properties (i.e., patterns) of haptic feedback provided in the first device 310 or the second device 320, with reference to a position, posture, or motion of the first device 310 or the second device 320.

Further, according to one embodiment of the invention, in response to the occurrence of a triggering event, the user interface provision system 200 according to one embodiment of the invention may function to determine properties (i.e., patterns) of haptic feedback provided in the first device 310 or the second device 320, with reference to a display state of a region associated with the triggering event. For example, an intensity, time, generation location, or the like of haptic feedback provided in the first device 310 or the second device 320 may be determined according to a color, brightness, depth, or the like of a graphical object displayed in a region being touched by the user.

Furthermore, according to one embodiment of the invention, in response to the occurrence of a triggering event, the user interface provision system 200 according to one embodiment of the invention may function to determine properties of haptic feedback respectively provided in the first device 310 and the second device 320, with reference to contents or functions associated with the triggering event.

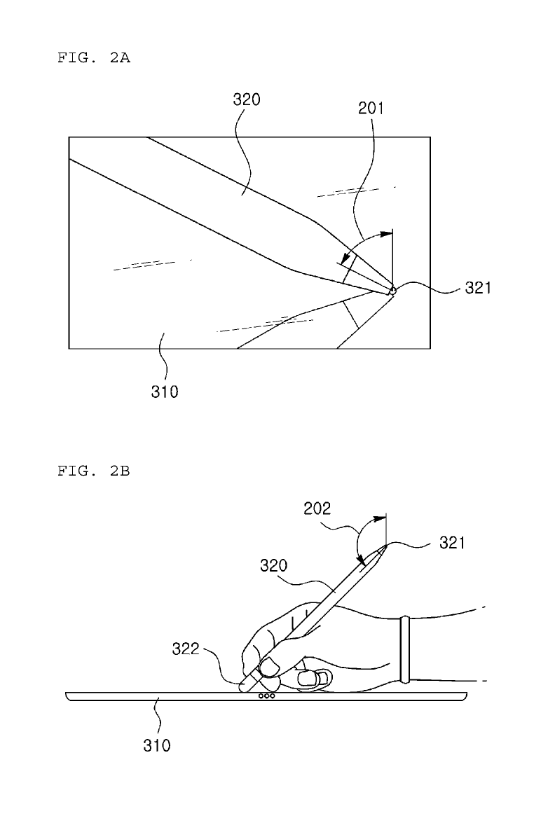

FIGS. 2A to 4B illustratively show how to control properties of haptic feedback with reference to physical properties, including a position, posture, or motion, of the first device or the second device according to one embodiment of the invention.

First, referring to FIGS. 2A and 2B, the intensity of haptic feedback may be controlled according to an angle 201, 202 between the first device 310 being a tablet and the second device 320 being a smart pen device. For example, as an angle between a normal direction of a display screen of the first device 310 and a longitudinal direction of the second device 320 is decreased (i.e., as the second device 320 is placed in a more standing position with respect to the display screen of the first device 310), the intensity of haptic feedback provided in the first device 310 may be decreased and that of haptic feedback provided in the second device 320 may be increased. To the contrary, as the angle between the normal direction of the display screen of the first device 310 and the longitudinal direction of the second device 320 is increased (i.e., as the second device 320 is placed in a more lying position with respect to the display screen of the first device 310), the intensity of haptic feedback provided in the first device 310 may be increased and that of haptic feedback provided in the second device 320 may be decreased.

Referring further to FIGS. 2A and 2B, the intensity of haptic feedback may be controlled according to a thickness of a nib (i.e., an area of contact with the display screen of the first device 310) of the second device 320 being the smart pen device. For example, as the thickness of a nib 321 of the second device 320 is thinned, the intensity of haptic feedback provided in the first device 310 may be decreased and that of haptic feedback provided in the second device 320 may be increased (see FIG. 2A). To the contrary, as the thickness of a nib 322 of the second device 320 is thickened, the intensity of haptic feedback provided in the first device 310 may be increased and that of haptic feedback provided in the second device 320 may be decreased (see FIG. 2B).

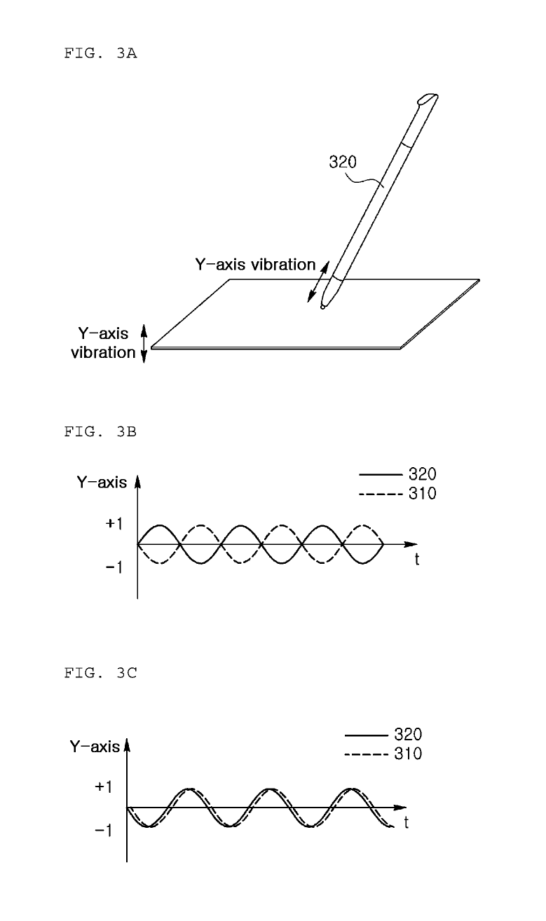

Next, referring to FIG. 3A to 3C, it may be assumed that haptic feedback provided in the first device 310 being a tablet is generated in a pattern in which the direction of the haptic feedback is periodically switched along a Y-axis perpendicular to a display screen of the first device 310, and that haptic feedback provided in the second device 320 being a smart pen device is generated in a pattern in which the direction of the haptic feedback is periodically switched along an axis parallel to a longitudinal direction of the second device 320 (which may be substantially identical to the above Y-axis). In this case, when the haptic feedback provided in the first device 310 and that provided in the second device 320 have the same period and the opposite directions, they may offset each other so that the intensity of haptic feedback felt by a user may be decreased (see FIG. 3A). To the contrary, when the haptic feedback provided in the first device 310 and that provided in the second device 320 have the same period and direction, they may reinforce each other so that the intensity of haptic feedback felt by the user may be increased (see FIG. 3B). Meanwhile, the change in the user experience according to the above offset or reinforcement may be further increased as an angle between a normal direction of the display screen of the first device 310 and the longitudinal direction of the second device 320 is decreased.

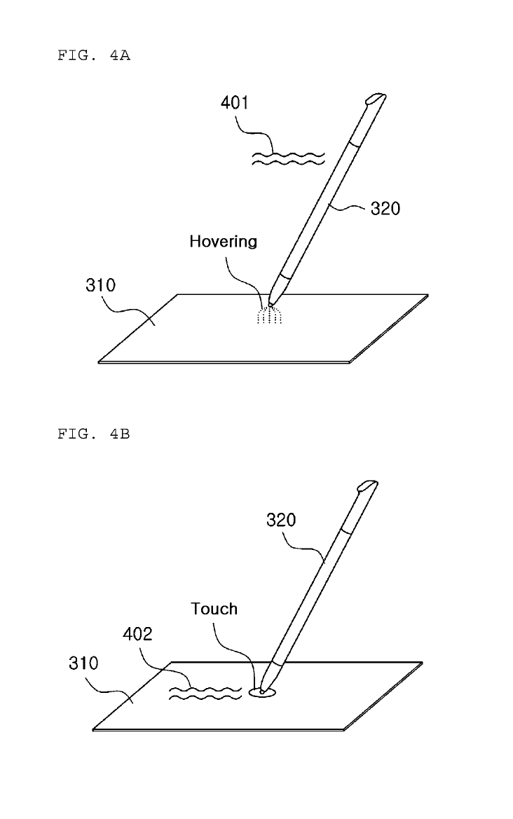

Next, referring to FIGS. 4A and 4B, the location where haptic feedback is provided may be changed as the second device 320 being a smart pen device hovers over or touches a display screen of the first device 310 being a tablet. For example, when a nib part of the second device 320 floats (i.e., hovers) over within a predetermined distance from a location where a graphical object is displayed on the display screen of the first device 310, haptic feedback 401 may be provided in the second device 320 so that a user operating the second device 320 may be induced to touch the graphical object on the display screen of the first device 310. As another example, when the nib part of the second device 320 touches the location where the graphical object is displayed on the display screen of the first device 310, haptic feedback 402 may be provided in the first device 320 so that the user operating the second device 320 may directly sense that the graphical object on the display screen of the first device 310 is touched.

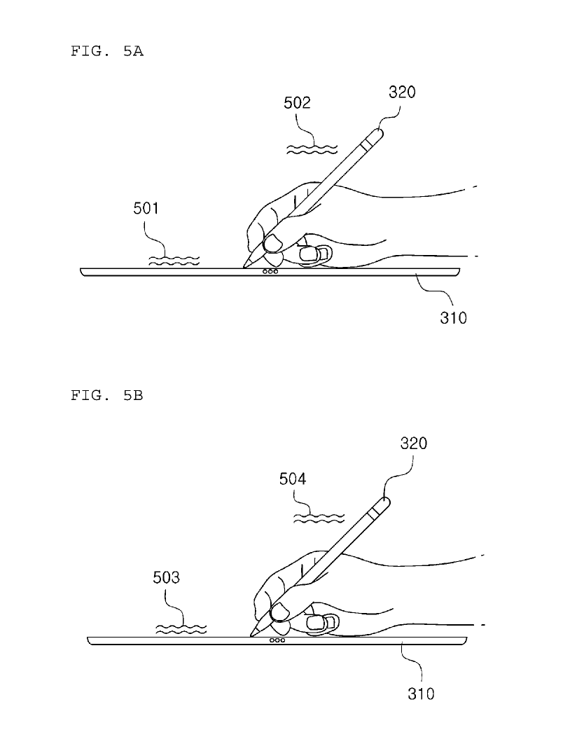

FIGS. 5A to 9C illustratively show how to control properties of haptic feedback with reference to a display state of a region, contents, or functions associated with a triggering event according to one embodiment of the invention.

First, referring to FIGS. 5A and 5B, it may be assumed that a location or intensity in which haptic feedback is provided is complementarily controlled between the two devices 310, 320.

Specifically, referring to FIG. 5A, when a user inputs an operation to a graphical object displayed on a display screen of the first device 310 being a tablet using the second device 320 being a smart pen device, so that a file corresponding to the graphical object is copied, the intensity of haptic feedback 501 provided in the first device 310 may be decreased and that of haptic feedback 502 provided in the second device 320 may be increased, so that the user may be provided with a user experience (UX) in which the user feels as if the haptic feedback having been provided in the first device 310 has been brought to the second device 320.

Next, referring to FIG. 5B, when a user inputs an operation to a certain point on a display screen of the first device 310 being a tablet using the second device 320 being a smart pen device, so that a file is pasted into a storage of the first device 310, the intensity of haptic feedback 504 provided in the second device 320 may be decreased and that of haptic feedback 503 provided in the first device 310 may be increased, so that the user may be provided with a user experience in which the user feels as if the haptic feedback having been provided in the second device 320 has been brought to the first device 310.

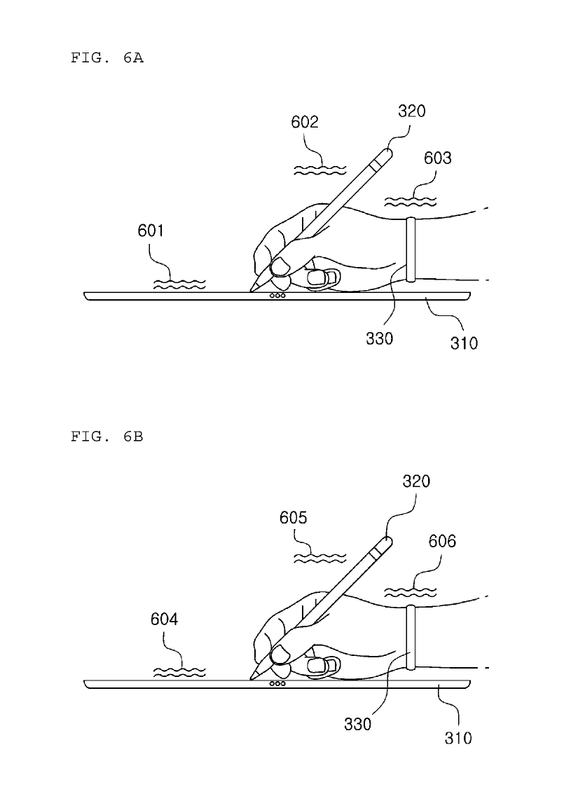

Next, referring to FIGS. 6A and 6B, it may be assumed that a location or intensity in which haptic feedback is provided is complementarily controlled between the three devices 310, 320, 330.

Specifically, referring to FIG. 6A, when a user inputs an operation to a graphical object displayed on a display screen of the first device 310 being a tablet by operating the second device 320 being a smart pen device with a hand whose wrist wears the third device 330 being a smart band, so that a file corresponding to the graphical object is copied, the intensity of haptic feedback 601 provided in the first device 310 may be decreased, that of haptic feedback 602 provided in the second device 320 may be increased and then decreased, and that of haptic feedback 603 provided in the third device 330 may be increased, so that the user may be provided with a user experience in which the user feels as if the haptic feedback having been provided in the first device 310 has been brought to the third device 330 via the second device 320.

Next, referring to FIG. 6B, when a user inputs an operation to a graphical object displayed on a display screen of the first device 310 being a tablet by operating the second device 320 being a smart pen device with a hand whose wrist wears the third device 330 being a smart band, so that a file is pasted into a storage of the first device 310, the intensity of haptic feedback 606 provided in the third device 330 may be decreased, that of haptic feedback 605 provided in the second device 320 may be increased and then decreased, and that of haptic feedback 604 provided in the first device 310 may be increased, so that the user may be provided with a user experience in which the user feels as if the haptic feedback having been provided in the third device 330 has been brought to the first device 310 via the second device 320.

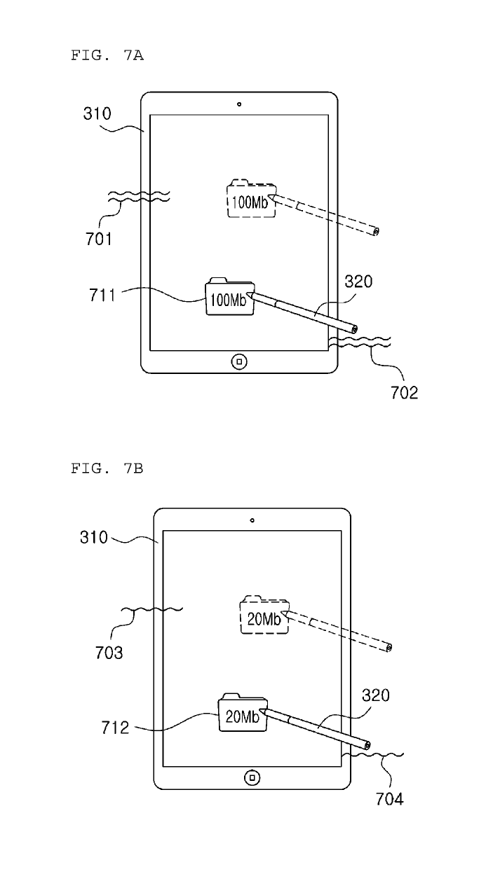

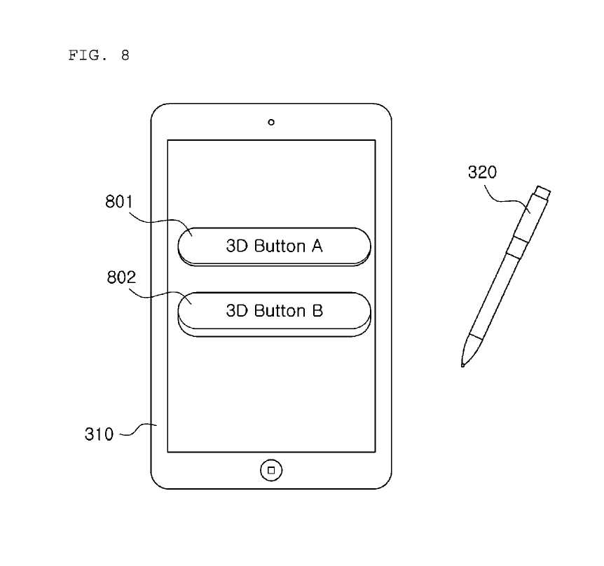

Next, referring to FIGS. 7A to 8, the properties of haptic feedback may be controlled according to the properties (e.g., appearance, properties or texture of a material metaphorically represented by the appearance, etc.) of a graphical object operated by the second device 320 being a smart pen device, among those displayed on a display screen of the first device 310 being a tablet, or according to the properties (e.g., file size, number, types, etc.) of contents corresponding to the graphical object.

Specifically, referring to FIGS. 7A and 7B, when the file size of a content corresponding to a graphical object displayed on the display screen of the first device 310 and dragged by the second device 320 being the smart pen device is 100 MB (711), the intensity of haptic feedback 701, 702 provided in the first device 310 or the second device 320 may be determined to be relatively greater than that of haptic feedback 703, 704 provided in the first device 310 or the second device 320 when the file size thereof is 20 MB (712). Accordingly, a user may be provided with a user experience in which the user feels stronger resistance as the file size of the content is greater.

Further, referring to FIG. 8, when the depth or thickness of the appearance of a graphical object displayed on a display screen of the first device 310 and touched by the second device 320 being a smart pen device is relatively small (801), haptic feedback may be generated in a vibration motor installed in the lower part of the second device 320. When the depth or thickness of the appearance of the graphical object is relatively large (802), haptic feedback may be generated in a vibration motor installed in the upper part of the second device 320. Accordingly, a user may be provided with a user experience in which the user intuitively feels the depth of the graphical object.

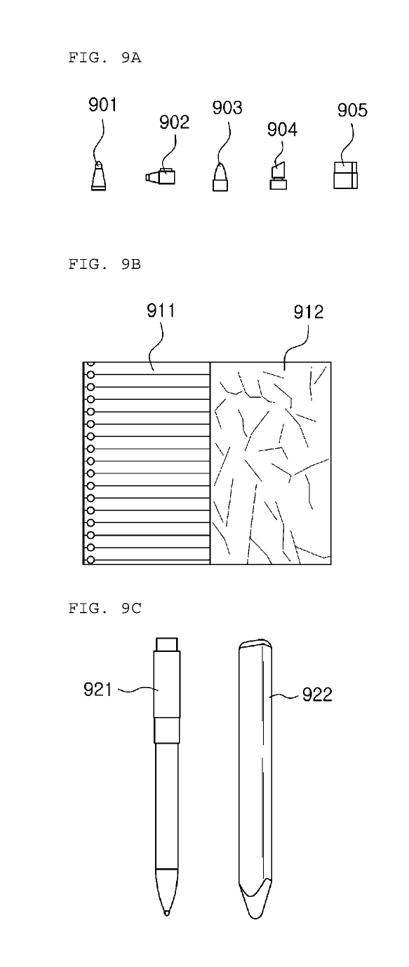

Next, referring to FIGS. 9A to 9C, while the first device 310 being a tablet and the second device 320 being a smart pen device 320 interact with each other, the patterns of haptic feedback may be changed according to types 901, 902, 903, 904, 905 of input tools determined corresponding to the second device 320 (see FIG. 9A), according to textures 911, 912 of backgrounds (or layers) displayed on a display screen of the first device 310 (see FIG. 9B), and according to types 921, 922 of the second device (see FIG. 9C).

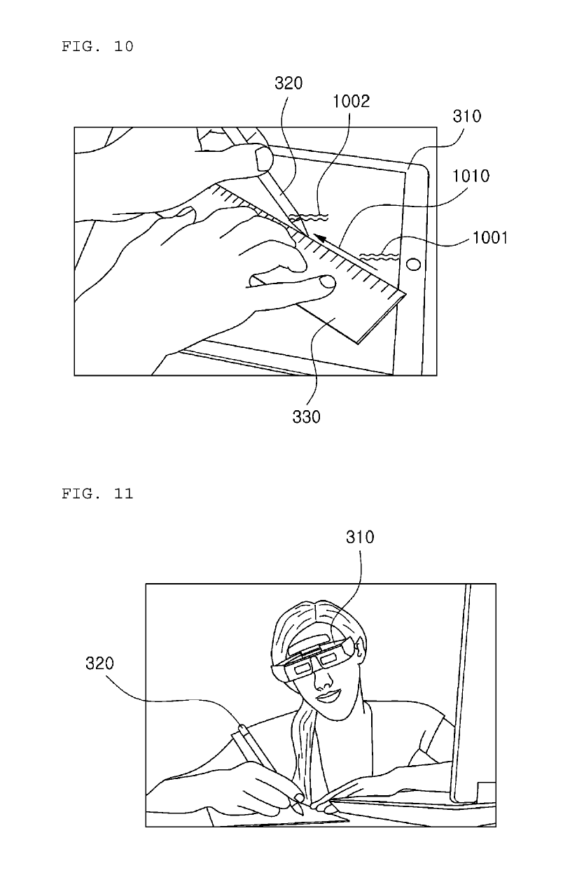

FIGS. 10 and 11 illustratively show how to control properties of haptic feedback with reference to interaction occurring between different kinds of devices according to one embodiment of the invention.

First, referring to FIG. 10, when a user draws a graphical object on a display screen of the first device 310 being a tablet, using the second device 320 being a smart pen device and the third device 330 being a smart ruler device together, the location of a region where haptic feedback is generated in the first device 310 or the third device 330 may be moved according to a motion of a nib of the second device 320.

Next, referring to FIG. 11, when the second device 320 being a smart pen device operated by a user interacts with a augmented reality (or virtual reality) object generated by the first device 310 being a head-mounted device, the properties of haptic feedback provided in the first device 310 or the second device 320 may be dynamically controlled on the basis of the interaction.

It is noted that although the embodiments in which the first device 310 is a tablet, a smart phone, or a head-mounted device and the second device 320 is a smart pen device have been mainly described above, the present invention is not necessarily limited thereto, and the first and second devices may also be implemented with various types of other aforementioned devices, as long as the objects of the invention may be achieved.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing a user interface, comprising the steps of:
determining whether a triggering event occurs that causes haptic feedback in at least one of a first device and a second device; and
when it is determined that the triggering event occurs, controlling properties of haptic feedback provided in the first device and the second device, with reference to at least one of information on interaction between the first device and the second device associated with the triggering event, information on a position, posture, or motion of the first device or the second device associated with the triggering event, information on pressure applied to the first device or the second device associated with the triggering event, information on a display state associated with the triggering event, and information on contents or functions associated with the triggering event,
wherein the properties of haptic feedback provided in the first device and the properties of haptic feedback provided in the second device are complementarily controlled, and
wherein the second device is a smart pen device capable of interacting with the first device.

2. The method of claim 1, wherein the triggering event includes at least one of:
an event in which an operation occurs that causes the second device to contact the first device;
an event in which an operation occurs that causes the second device to hover over the first device;
an event in which a relative relationship between positions, postures, or motions of the first device and the second device corresponds to a predetermined relationship; and
an event in which the first device and the second device interact with each other.

3. The method of claim 1, wherein the properties of haptic feedback are specified by at least one of a time, order, interval, intensity, location, and direction in which the haptic feedback is provided.

4. The method of claim 1, wherein any one of the first device and the second device contacts a body of a user, and
wherein in the controlling step, upon the occurrence of the triggering event, the properties of haptic feedback provided in the first device and the second device are controlled with further reference to acquired information on the body contact location.

5. The method of claim 1, wherein the first device is a head-mounted device (HMD) configured to generate an augmented reality (AR) object, and
wherein in the controlling step, upon the occurrence of the triggering event, the properties of haptic feedback provided in the first device and the second device are controlled with further reference to information on interaction between the augmented reality object generated by the first device and the second device.

6. A non-transitory computer-readable recording medium having stored thereon a computer program for executing the method of claim 1.

7. A device for providing a user interface, comprising:
a sensing module configured to determine whether a triggering event occurs that causes haptic feedback in at least one of the device and another device; and
a program module configured to, when it is determined that the triggering event occurs, control properties of haptic feedback provided in the device and the another device, with reference to at least one of information on interaction between the device and the another device associated with the triggering event, information on a position, posture, or motion of the device or the another device associated with the triggering event, information on pressure applied to the device or the another device associated with the triggering event, information on a display state associated with the triggering event, and information on contents or functions associated with the triggering event,
wherein the properties of haptic feedback provided in the device and the properties of haptic feedback provided in the another device are complementarily controlled, and
wherein the another device is a smart pen device capable of interacting with the device.

8. A system for providing a user interface, comprising:
a control unit configured to determine whether a triggering event occurs that causes haptic feedback in at least one of a first device and a second device, and when it is determined that the triggering event occurs, control properties of haptic feedback provided in the first device and the second device, with reference to at least one of information on interaction between the first device and the second device associated with the triggering event, information on a position, posture, or motion of the first device or the second device associated with the triggering event, information on pressure applied to the first device or the second device associated with the triggering event, information on a display state associated with the triggering event, and information on contents or functions associated with the triggering event; and
a storage configured to store information provided from at least one of the first device and the second device,
wherein the properties of haptic feedback provided in the first device and the properties of haptic feedback provided in the second device are complementarily controlled, and
wherein the second device is a smart pen device capable of interacting with the first device.

9. The system of claim 8, wherein the triggering event includes at least one of:
an event in which an operation occurs that causes the second device to contact the first device;
an event in which an operation occurs that causes the second device to hover over the first device;
an event in which a relative relationship between positions, postures, or motions of the first device and the second device corresponds to a predetermined relationship; and
an event in which the first device and the second device interact with each other.

10. The system of claim 8, wherein the properties of haptic feedback are specified by at least one of a time, order, interval, intensity, location, and direction in which the haptic feedback is provided.

11. The system of claim 8, wherein any one of the first device and the second device contacts a body of a user, and
wherein upon the occurrence of the triggering event, the control unit is configured to control the properties of haptic feedback provided in the first device and the second device, with further reference to acquired information on the body contact location.

12. The system of claim 8, wherein the first device is a head-mounted device (HMD) configured to generate an augmented reality (AR) object, and
wherein upon the occurrence of the triggering event, the control unit is configured to control the properties of haptic feedback provided in the first device and the second device, with further reference to information on interaction between the augmented reality object generated by the first device and the second device.
